(19) United States
(12) Patent Application Publication
(10) Pub. No.: US 2022/0337143 A1
(43) Pub. Date: Oct. 20, 2022

(54) ROTOR OF ROTARY ELECTRIC MACHINE

(71) Applicant: EXEDY Corporation, Osaka (JP)

(72) Inventors: Tomohiro WADA, Osaka (JP); Kenji KITADA, Osaka (JP)

(21) Appl. No.: 17/708,427

(22) Filed: Mar. 30, 2022

(30) Foreign Application Priority Data
Apr. 20, 2021 (JP) 2021-071042

(51) Int. Cl. H02K 21/04

(52) U.S. Cl. CPC H02K 21/044

(57) ABSTRACT

A rotor of a rotary electric machine includes first and second magnetic poles, and first and second holding members. The first magnetic pole has a first annular portion and first claw portions. The first claw portions extend axially from the first annular portion, and are spaced apart from each other in a circumferential direction. The second magnetic pole includes a second annular portion and second claw portions. The second annular portion is disposed on a first side in an axial direction to the first annular portion. The second claw portions extend axially from the second annular portion, and are disposed alternately with the first claw portions in the circumferential direction. The first holding member includes a first engaging portion disposed radially outward to a tip-portion of each first claw portion. The second holding member includes a second engaging portion disposed radially outward to a tip-portion of each second claw portion.

### CROSS-REFERENCE TO RELATED APPLICATIONS

This application claims priority to Japanese Patent Application No. 2021-071042 filed Apr. 20, 2021. The entire contents of that application are incorporated by reference herein in their entirety.

### TECHNICAL FIELD

The present invention relates to a rotor of a rotary electric machine.

### BACKGROUND ART

A rotary electric machine including a rotor is used in a vehicle or the like. As a conventional rotor, a claw pole type rotor including a magnetic pole with a shape of a claw (hereinafter referred to as a claw-shaped magnetic pole) is known. In such a rotor, it is desired to suppress the deformation of the claw-shaped magnetic pole. Japanese Laid-open Patent Application Publication No. 2019-213441, International Publication No. 2018/139561, Japanese Laid-open Patent Application Publication No. 2017-220989, Japanese Laid-open Patent Application Publication No. H1-318532, and Japanese Laid-open Patent Application Publication No. S64-85547 propose a rotor provided with a member for preventing deformation of a claw-shaped magnetic pole.

### BRIEF SUMMARY

Deformation of a claw-shaped magnetic pole may be suppressed by a method different from that of the rotors of the rotary electric machines of Japanese Laid-open Patent Application Publication No. 2019-213441, International Publication No. 2018/139561, Japanese Laid-open Patent Application Publication No. 2017-220989, Japanese Laid-open Patent Application Publication No. H1-318532, and Japanese Laid-open Patent Application Publication No. S64-85547.

It is an object of the present invention to provide a rotor of a rotary electric machine that suppresses deformation of a claw-shaped magnetic pole.

(1) A rotor of a rotary electric machine according to one aspect of the present invention includes a first magnetic pole, a second magnetic pole, a first holding member, and a second holding member. The first magnetic pole has a first annular portion and a first claw portion. The first claw portion extends axially from the first annular portion. The first claw portions are disposed so as to be spaced at intervals from each other in a circumferential direction. The second magnetic pole includes a second annular portion and a second claw portion. The second annular portion is disposed on a first side in an axial direction with respect to the first annular portion. The second claw portion extends axially from the second annular portion. The second claw portions are disposed alternately with the first claw portions in the circumferential. The first holding member includes an annular first engaging portion disposed radially outward with respect to a tip portion of the first claw portion. The second holding member includes an annular second engaging portion disposed radially outward with respect to a tip portion of the second claw portion.

According to this configuration, the first engaging portion of the annular first holding member can abut on the tip portion of the first claw portion. Similarly, the second engaging portion of the annular second holding member can abut on the tip portion of the second claw portion. Therefore, it is possible to prevent the tip portions of the first magnetic pole and the second magnetic pole from expanding toward the outer peripheral side beyond the inner diameters of the first and second engaging portions during the rotation of the rotor and being deformed.

(2) Preferably, an inner diameter of the first engaging portion is larger than an outer diameter of a virtual cylinder composed of outer peripheral surfaces of the tip portions of the plurality of first claw portions. An inner diameter of the second engaging portion is larger than an outer diameter of a virtual cylinder formed by outer peripheral surfaces of the tip portions of the plurality of second claw portions.

In this case, there is a gap between the inner peripheral surface of the first engaging portion and the outer peripheral surface of the virtual cylinder formed by the outer peripheral surfaces of the tip portions of the plurality of first claw portions. Further, there is a gap between the inner peripheral surface of the second engaging portion and the outer peripheral surface of the virtual cylinder formed by the outer peripheral surfaces of the tip portions of the plurality of second claw portions. Therefore, even if the rotor is provided with a permanent magnet, cutting chips due to press-fitting or the like do not adhere to the permanent magnet during assembly.

(3) Preferably, the first holding member further includes a first main body portion. The first main body portion is annular. The first engaging portion extends from the first main body portion to a second side in the axial direction. In this case, when a torque converter is disposed in the axial direction of the rotor, the first engaging portion can be used as a member for centering the torque converter.

(4) Preferably, the first claw portion includes a first engaging recess. The first engaging recess extends in the circumferential direction at outer peripheral portion of the tip portion of the first claw portion. The first engaging portion is configured to engage the first engaging recess. In this case, since it can be assembled in a spigot format, positioning becomes easy.

(5) Preferably, the rotor of the rotary electric machine further includes a field coil disposed radially inward with respect to the first claw portion and the second claw portion.

(6) Preferably, the field coil is longer than the first claw portion in the axial direction. In this case, a stronger magnetic flux can be generated.

(7) Preferably, the rotor of the rotary electric machine further includes a permanent magnet disposed between the first claw portion and the second claw portion in the circumferential direction. In this case, the output performance of the rotary electric machine can be improved by using the magnetic flux generated by the permanent magnet.

(8) Preferably, the rotor of the rotary electric machine further includes a fall-out prevention mechanism disposed on the second side in the axial direction with respect to the second holding member. In this case, it is possible to prevent the second holding member from falling out.

(9) Preferably, the fall-out prevention mechanism includes an annular plate and a snap ring. The snap ring is disposed on the second side in the axial direction with respect to the plate.

In the present invention as described above, it is possible to provide a rotor of a rotary electric machine in which deformation of a claw-shaped magnetic pole is suppressed.

### BRIEF DESCRIPTION OF THE DRAWINGS

FIG. 1 is a cross-sectional view of a rotor of a rotary electric machine according to the present invention.

FIG. 2 is a perspective view of the rotor of the rotary electric machine according to the present invention.

FIG. 3 is a perspective view of the rotor of the rotary electric machine according to the present invention in a disassembled state.

FIG. 4 is a cross-sectional view of a first magnetic pole.

FIG. 5 is a perspective view of the first magnetic pole as viewed from first side in an axial direction.

FIG. 6 is a perspective view of one phase of the rotor of the rotary electric machine according to the present invention.

FIG. 7 is a cross-sectional view of a second magnetic pole.

FIG. 8 is an enlarged schematic cross-sectional view of a part of the rotor of the rotary electric machine according to the present invention.

FIG. 9 is a diagram showing a positional relationship between the first magnetic pole and the second magnetic pole and a permanent magnet.

FIG. 10 is a perspective view showing a fall-out prevention mechanism.

FIG. 11 is an enlarged cross-sectional view of a part of the rotor of the rotary electric machine according to the present invention.

FIG. 12 is a perspective view showing a core plate.

FIG. 13 is an enlarged schematic cross-sectional view of a part of a modified example of the rotor of the rotary electric machine of the present invention.

FIG. 14 is a diagram showing a positional relationship between the first magnetic pole and the second magnetic pole, and a permanent magnet of a modified example of a rotor of a rotary electric machine according to the present invention.

### DETAILED DESCRIPTION

### <Overall Configuration>

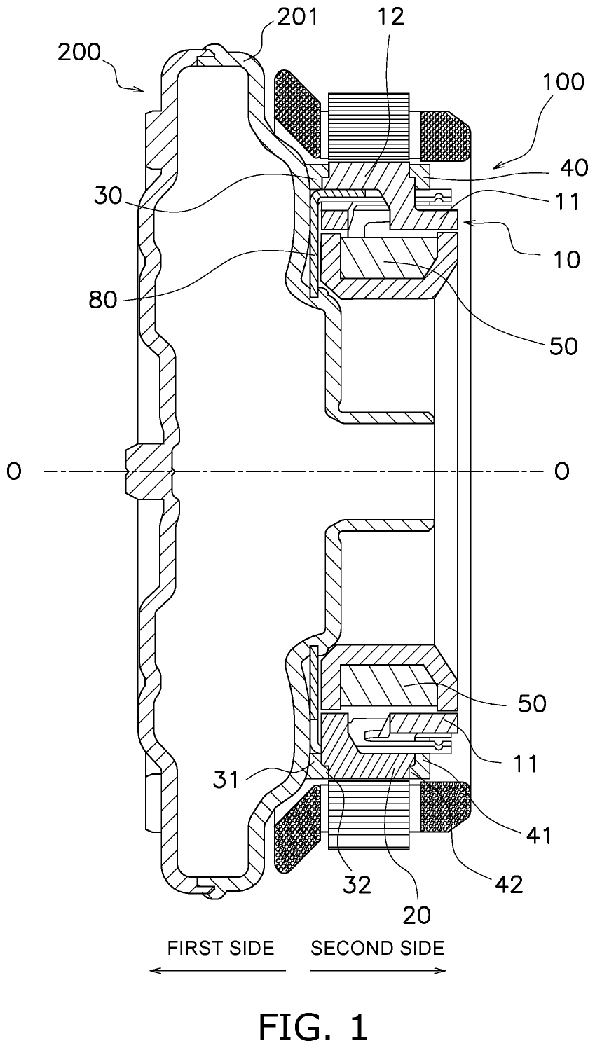

FIG. 1 shows a rotor 100 of a rotary electric machine according to an exemplary embodiment of the present invention. In the cross-sectional view of FIG. 1, the 0-0 line is a rotation axis. In the following description, “axial direction” indicates the direction in which the rotation axis O extends, left side of FIG. 1 is a “first side in the axial direction”, and right side of FIG. 1 is a “second side in the axial direction”. Further, “radially” means the radial direction of a circle centered on the rotation axis O. “Circumferential direction” means the circumferential direction of the circle centered on the rotation axis O.

The rotor 100 of the rotary electric machine is disposed on the second side in the axial direction with respect to a torque converter 200. Specifically, the rotor 100 of the rotary electric machine is attached to an impeller shell 201 of the torque converter 200. An engine (not shown) is disposed on the first side in the axial direction of the torque converter 200. A transmission (not illustrated) is disposed on the second side in the axial direction of the rotor 100 of the rotary electric machine. The rotor 100 of the rotary electric machine, an output shaft of the engine, and the torque converter 200 have the same rotary shaft O.

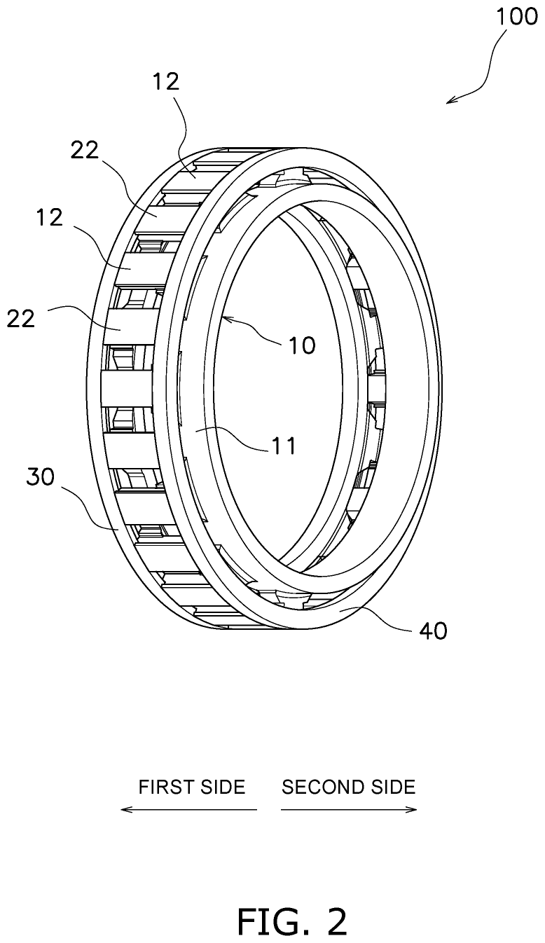

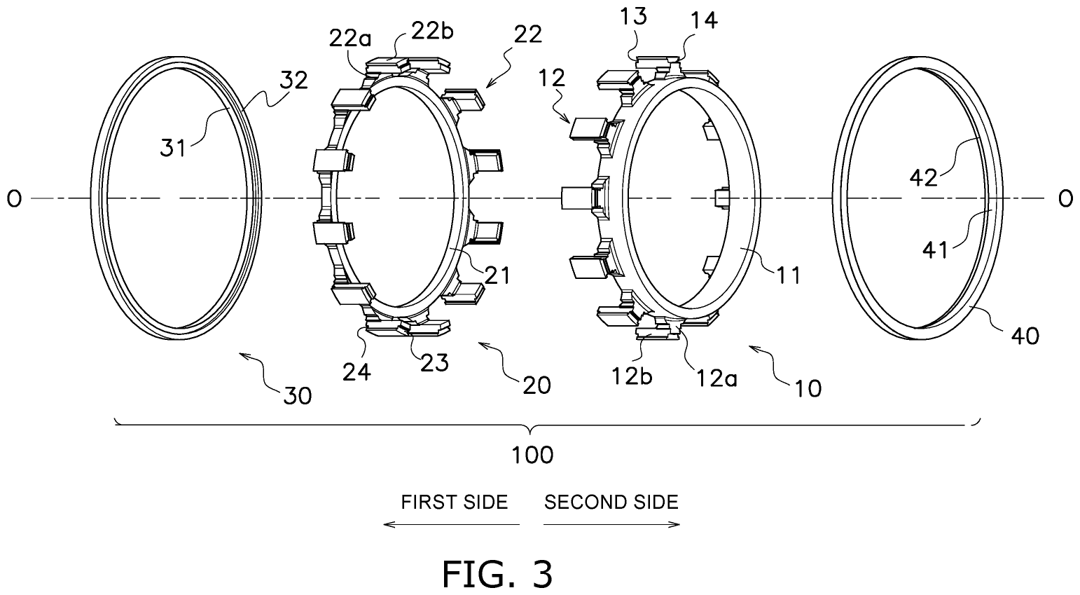

Referring to FIGS. 2 and 3, the rotor 100 of the rotary electric machine is a claw pole type. The rotor 100 of the rotary electric machine includes a first magnetic pole 10, a second magnetic pole 20, a first holding member 30, and a second holding member 40. The rotor 100 of the rotary electric machine further includes a permanent magnet 60, a fall-out prevention mechanism 70, and a core plate 80.

### <First Magnetic Pole 10>

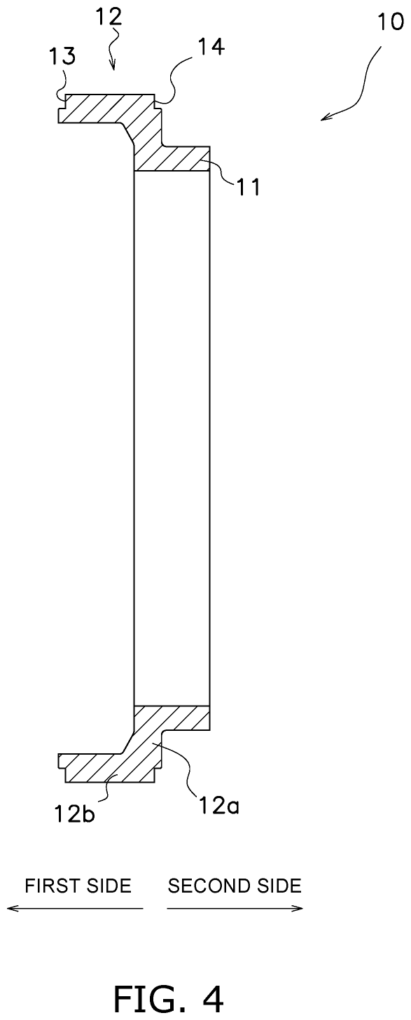

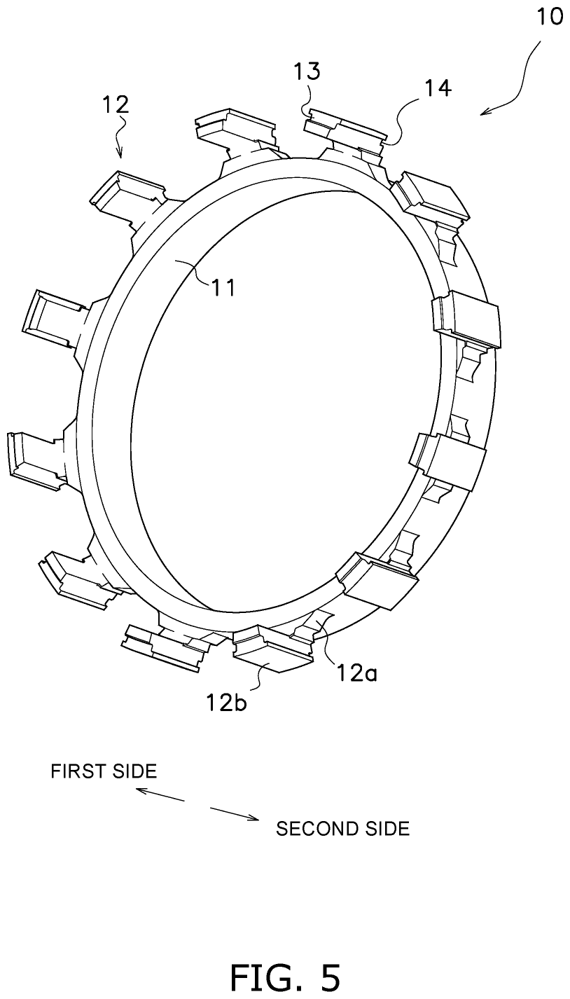

Referring to FIGS. 4 to 6, the first magnetic pole 10 is rotatably disposed. The first magnetic pole 10 is composed of a soft magnetic material, such as iron. The first magnetic pole 10 has a first annular portion 11 and a plurality of first claw portions 12.

The first annular portion 11 is annular and has a hole in its central portion.

The first claw portion 12 extends from the first annular portion 11 to the first side in the axial direction. More specifically, the first claw portion 12 extends from an outer peripheral portion of the first annular portion 11 to the first side in the axial direction. The first claw portions 12 are disposed at intervals from each other in the circumferential direction. The lengths of the plurality of first claw portions 12 in the axial direction are all the same. The outer diameter of a virtual cylinder formed of the outer peripheral surfaces of the plurality of first claw portions 12 is larger than the outer diameter of the first annular portion 11. The first claw portion 12 is in a non-contact state with respect to the second magnetic pole 20. The first claw portion 12 is configured to have a radial gap with respect to the second annular portion 21 of the second magnetic pole 20.

The first claw portion 12 has a first engaging recess 13. The first engaging recess 13 extends in the circumferential direction at the outer peripheral portion of the tip portion of the first claw portion 12. The first engaging recess 13 is a step portion formed by cutting out the outer periphery edge of the tip portion of the first claw portion 12. The outer peripheral surface of each first engaging recess 13 is located on the same circumference around the rotation axis O.

The first claw portion 12 has a second engaging recess 14. The second engaging recess 14 extends in the circumferential direction at the outer peripheral portion of the base end portion of the first claw portion 12. The second engaging recess 14 is a step portion formed by cutting out the outer periphery edge of the base end portion of the first claw portion 12. The outer peripheral surface of each second engaging recess 14 is located on the same circumference around the rotation axis O.

More specifically, the first claw portion 12 includes a first leg portion 12a and a first protrusion portion 12b. The first leg portion 12a extends radially outward from the first annular portion 11. More specifically, the first leg portion 12a extends radially outward from the outer peripheral portion of the first annular portion 11. The first protrusion portion 12b extends axially from the outer periphery portion of the first leg portion 12a to the first side in the axial direction. The first protrusion 12b is, for example, a rectangular thin plate.

### <Second Magnetic Pole 20>

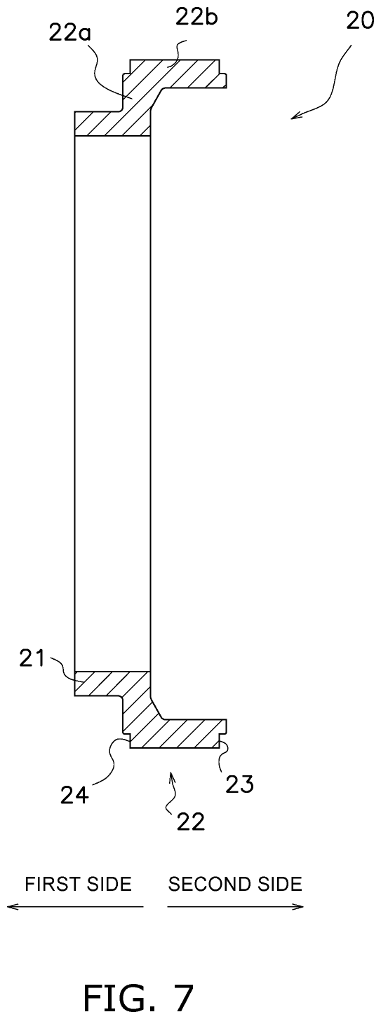

Referring to FIGS. 3, 6 and 7, the second magnetic pole 20 is disposed on the first side in the axial direction of the first magnetic pole 10 and is rotatably disposed. The second magnetic pole 20 is composed of a soft magnetic material, such as iron. The second magnetic pole 20 has a second annular portion 21 and a plurality of second claw portions 22.

The second annular portion 21 is annular and has a hole in its central portion. The second annular portion 21 is disposed on the first side in the axial direction with respect to the first annular portion 11.

The second claw portion 22 extends from the second annular portion 21 to the second side in the axial direction. More specifically, the second claw portion 22 extends from an outer peripheral portion of the second annular portion 21 to the second side in the axial direction. The second claw portions 22 are disposed at intervals from each other in the circumferential direction. The second claw portions 22 are disposed alternately with the first claw portions 12. The lengths of the plurality of second claw portions 22 in the axial direction are all the same. The outer diameter of a virtual cylinder formed of the outer peripheral surfaces of the plurality of second claw portions 22 is larger than the outer diameter of the second annular portion 21. The second claw portion 22 is in a non-contact state with respect to the first magnetic pole 10. The second claw portion 22 is configured to have a radial gap with respect to the first annular portion 11 of the first magnetic pole 10.

The second claw portion 22 has a third engaging recess 23. The third engaging recess 23 extends in the circumferential direction at the outer peripheral portion of the tip portion of the second claw portion 22. The third engaging recess 23 is a step portion formed by cutting out the outer periphery edge of the tip portion of the second claw portion 22. The outer peripheral surface of each third engaging recess 23 is located on the same circumference around the rotation axis O.

The second claw portion 22 has a fourth engaging recess 24. The fourth engaging recess 24 extends in the circumferential direction at the outer peripheral portion of the base end portion of the second claw portion 22. The fourth engaging recess 24 is a step portion formed by cutting out the outer periphery edge of the base end portion of the second claw portion 22. The outer peripheral surface of each fourth engaging recess 14 is located on the same circumference around the rotation axis O.

More specifically, the second claw portion 22 includes a second leg portion 12a and a second protrusion portion 22b. The second leg portion 22a extends radially outward from the second annular portion 21. More specifically, the second leg portion 22a extends radially outward from the outer peripheral portion of the second annular portion 21. The second protrusion portion 22b extends axially from the outer periphery portion of the second leg portion 22a to the second side in the axial direction. The second protrusion portion 22b is, for example, a rectangular thin plate.

### <First Holding Member 30>

The first holding member 30 is annular. The first holding member 30 is attached to the tip portion of the first claw portion 12 by fitting the gap.

Referring to FIG. 1, in detail, the first holding member 30 has a first main body portion 31 and a first engaging portion 32. The first main body portion 31 is annular.

The first engaging portion 32 protrudes to the second side in the axial direction at the outer peripheral portion of the first main body portion 31 and extends in the circumferential direction. The first engaging portion 32 is an annular shape. The first engaging portion 32 is composed of a step portion. The first engaging portion 32 is disposed radially outward with respect to the tip portion of the first claw portion 12. That is, the first holding member 30 is disposed radially outside the tip portion of the first claw portion 12.

The inner diameter of the first engaging portion 32 is larger than the outer diameter of the virtual cylinder composed of the outer peripheral surfaces of the tip portion of the first claw portion 12. That is, there is a gap between the inner peripheral surface of the first engaging portion 32 and the outer peripheral surface of the virtual cylinder formed by the outer peripheral surfaces of the tip portions of the plurality of first claw portions 12. However, at least one of the first engaging portions 32 may be supported by one or more members of the impeller shell 201 of the torque converter 200, the core plate 80, and the outer peripheral surface of the tip portion of at least one first claw portion 12.

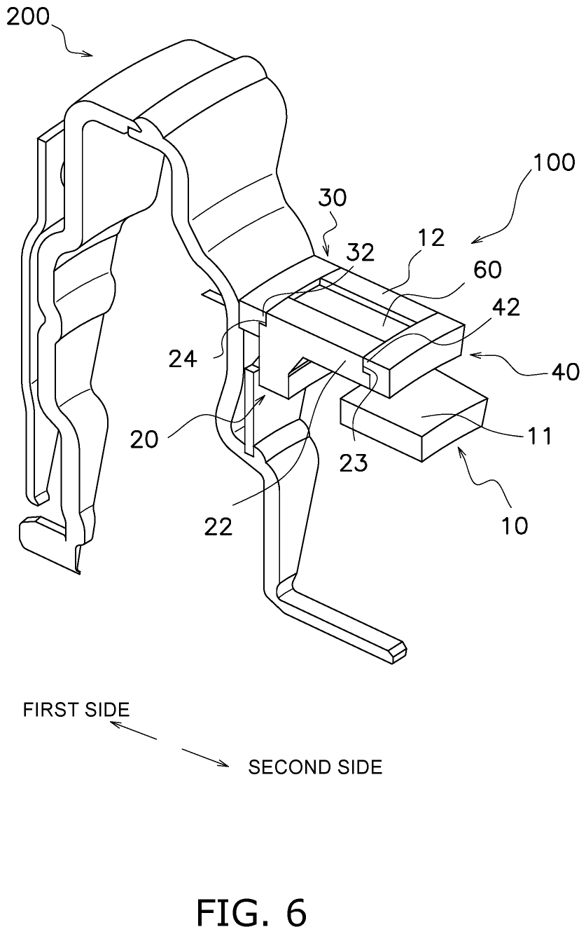

Referring to FIG. 6, the first engaging portion 32 engages with the first engaging recess 13 of the first claw portion 12 and the fourth engaging recess 24 of the second claw portion 22. In this case, since it can be assembled in a spigot format, positioning becomes easy.

The first holding member 30 is composed of a non-magnetic material. The non-magnetic material is, for example, aluminum, austenitic stainless steel, etc.

### <Second Holding Member 40>

The second holding member 40 is annular. The second holding member 40 is attached to the tip portion of the second claw portion 22 by fitting the gap.

Referring to FIG. 1, in detail, the second holding member 40 has a second main body portion 41 and a second engaging portion 42. The second main body portion 41 is annular.

The second engaging portion 42 protrudes to the first side in the axial direction at the outer peripheral portion of the second main body portion 41 and extends in the circumferential direction. The second engaging portion 42 is annular. The second engaging portion 42 is composed of a step portion. The second engaging portion 42 is disposed radially outward with respect to the tip portion of the second claw portion 22. That is, the second holding member 40 is disposed radially outside the tip portion of the second claw portion 22.

The inner diameter of the second engaging portion 42 is larger than the outer diameter of a virtual cylinder formed by outer peripheral surfaces of the tip portions of the plurality of second claw portions 22. That is, there is a gap between the inner peripheral surface of the second engaging portion 42 and the outer peripheral surface of the virtual cylinder formed by the outer peripheral surfaces of the tip portions of the plurality of second claw portions 22. However, at least one of the second engaging portions 42 may be supported by one or more members of the core plate 80 and at least one outer periphery of the tip portion of the second claw portion 22.

Referring to FIG. 6, the second engaging portion 42 engages with the second engaging recess 14 of the first claw portion 12 and the third engaging recess 23 of the second claw portion 22.

The second holding member 40 is composed of a non-magnetic material. The non-magnetic material is, for example, aluminum, austenitic stainless steel, etc.

### <Permanent Magnet 60>

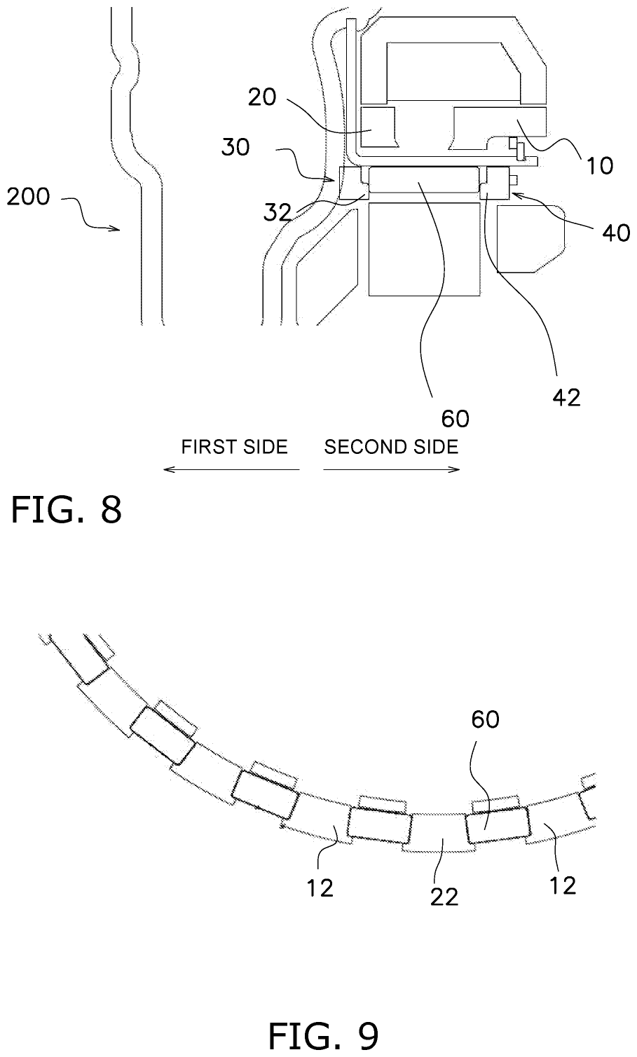

Referring to FIGS. 6, 8 and 9, the permanent magnet 60 has a rectangular plate shape. The permanent magnet 60 is disposed between the first claw portion 12 and the second claw portion 22 in the circumferential direction. The permanent magnet 60 is supported by being pressed from the outside in the radial direction by the first claw portion 12 and the second claw portion 22. The permanent magnet 60 can be disposed all or partly between the first claw portion 12 and the second claw portion 22. The end portion of the permanent magnet 60 on the first side in the axial direction is in contact with the first engaging portion 32 of the first holding member 30, and the second end portion of the permanent magnet 60 is in contact with the engaging portion 42 of the second holding member 40. As a result, the permanent magnet 60 is positioned in the axial direction. The first side end portion of the permanent magnet 60 is not in contact with the first main body portion 31 of the first holding member 30. The second side end portion of the permanent magnet 60 is not in contact with the second main body portion 41 of the second holding member 40.

The permanent magnet 60 is a magnet whose main raw material is neodymium or a magnet whose main raw material is ferrite. Specifically, as the permanent magnet 60, various types of permanent magnets 60, such as SmCo magnets, AlNiCo magnets, and neodymium bond magnets, can be used.

According to this configuration, the output performance of the rotary electric machine can be improved by using the magnetic flux generated by the permanent magnet 60.

### <Fall-Out Prevention Mechanism 70>

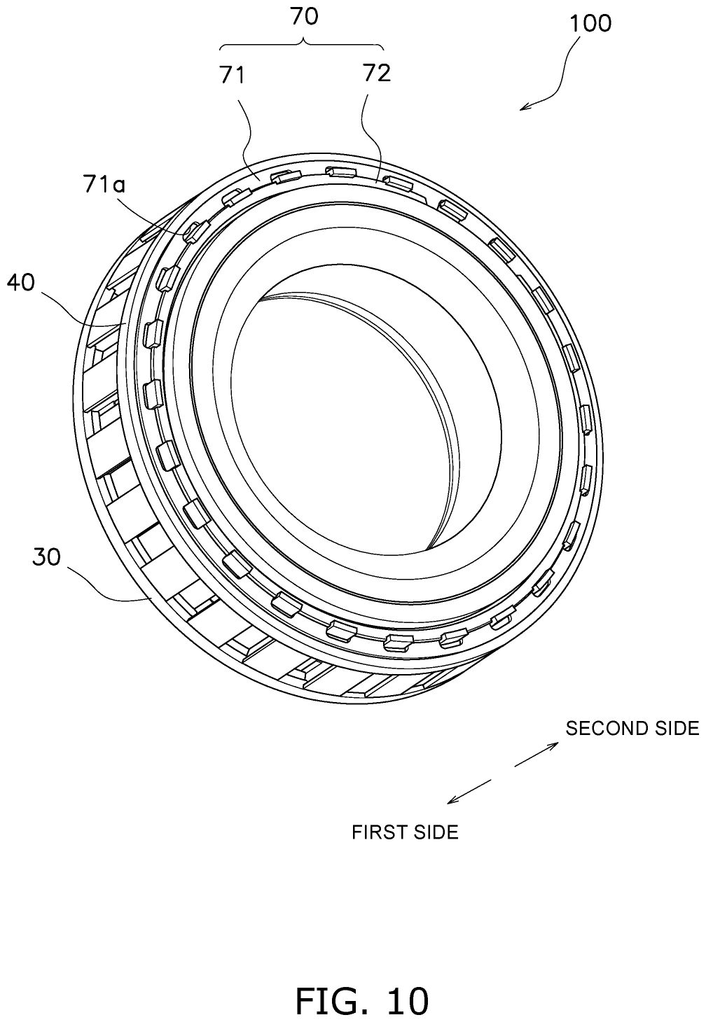

Referring to FIG. 10, the fall-off prevention mechanism 70 is disposed on the second side in the axial direction with respect to the second holding member 40. In the present embodiment, there is a gap between the inner peripheral surface of the second engaging portion 42 of the second holding member 40 and the outer peripheral surface of the virtual cylinder formed by the outer peripheral surface of the tip portions of the plurality of second claw portions 22. Therefore, the second holding member 40 may fall out during rotation. However, the fall-off prevention mechanism 70 can prevent the second holding member 40 from falling out.

The fall-off prevention mechanism 70 includes an annular plate 71 and a snap ring 72. The plate 71 has a plurality of through holes 71a penetrating in the axial direction. The through holes 71a are disposed at intervals from each other in the circumferential direction. The snap ring 72 is disposed on the second side in the axial direction with respect to the plate 71. The snap ring 72 regulates the axial movement of the plate 71.

### <Core Plate 80>

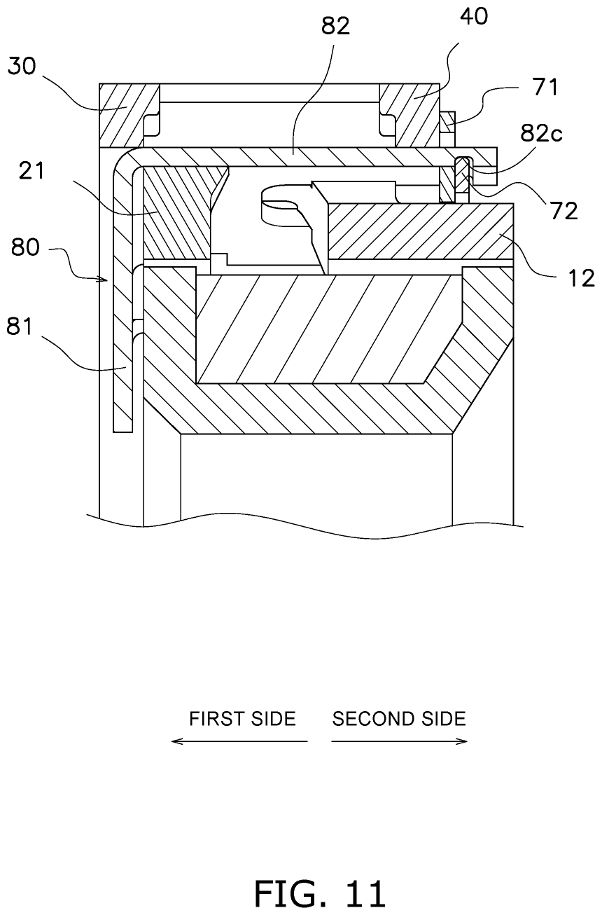

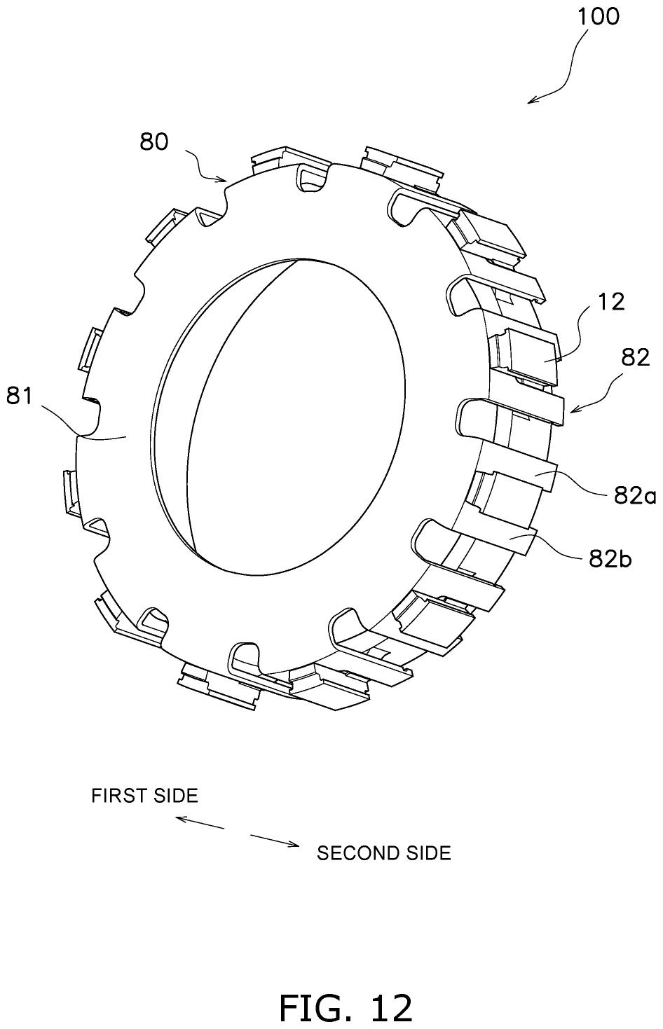

Referring to FIGS. 11 and 12, the core plate 80 is rotatably disposed. The core plate 80 is composed of a non-magnetic material. The non-magnetic material is, for example, aluminum, austenitic stainless steel or resin material. The core plate 80 has an annular base portion 81 and a plurality of engaging protrusion portions 82.

The annular base portion 81 is annular and has a hole in its central portion. In this hole, the annular base portion 81 is supported by the impeller shell 201 of the torque converter 200.

The engaging protrusion portion 82 extends to the second side in the axial direction from the annular base portion 81. More specifically, the engaging protrusion portion 82 extends to the second side in the axial direction from the outer peripheral portion of the annular base portion 81. The engaging protrusion portions 82 are disposed at intervals from each other in the circumferential direction. The axial lengths of the plurality of engaging protrusion portions 82 are all the same. The outer diameter of the virtual cylinder formed of the outer peripheral surfaces of the plurality of engaging protrusion portions 82 is larger than the outer diameter of the annular base portion 81. The engaging protrusion portion 82 includes a pair of leg portions 82a and 82b. The first claw portion 12 is disposed between the pair of leg portions 82a and 82b. The first claw portion 12 is supported by the portion between the pair of leg portions 82a and 82b. The second claw portion 22 of the second magnetic pole 20 is disposed between the engaging protrusion portions 82 that are adjacent to each other. The engaging protrusion portions 82 that are adjacent to each other support the second claw portion 22 by sandwiching it from the circumferential direction. With this configuration, the first magnetic pole 10 and the second magnetic pole 20 can be held in a non-contact state in the circumferential direction.

The plate 71 of the fall-out prevention mechanism 70 is disposed at the tip portion of the engaging protrusion portion 82. The engaging protrusion portion 82 passes through the through hole 71a of the plate 71. Further, the engaging protrusion portion 82 has a groove 82c on the inner peripheral surface of the tip portion. The groove 82c extends in the circumferential direction. The snap ring 72 is engaged with the groove 82c. That is, the snap ring 72 is pressed by the engaging protrusion portion 82. The engaging protrusion portion 82 is restricted from moving in the radial direction by the second engagement portion 42 of the second holding member 40. With this configuration, it is possible to prevent the tip portion of the engaging protrusion portion 82 from opening toward the outer peripheral side during rotation.

### <Field Coil 50>

Referring to FIG. 1, the rotary electric machine according to the exemplary embodiment of the present invention includes a field coil 50 on the radial inner peripheral side of the rotor 100. The field coil 50 is disposed radially inward with respect to the first claw portion 12 and the second claw portion 22. In the present embodiment, the rotor 100 is disposed in the axial direction with respect to the torque converter 200. Therefore, the field coil 50 can be disposed radially inward with respect to the first claw portion 12 and the second claw portion 22. As a result, the annular first holding member 30 can abut on the tip portion of the first claw portion 12. Similarly, the annular second holding member 40 can abut on the base end portion of the first claw portion 12.

The field coil 50 excites a magnetic flux by a direct current. The field coil 50 is longer than the first claw portion in the axial direction. As a result, the output performance of the rotary electric machine can be improved by using the magnetic flux of the field coil 50 in addition to the magnetic flux of the permanent magnet 60.

### <Operation and Action>

In a rotary electric machine using the rotor 100 configured as described above, a case where the rotary electric machine is used as a starter to exert a starting function will be described. Based on the engine start command, an inverter (not shown) is driven to pass a three-phase alternating current through the stator to magnetize the stator, and a current is passed through the field coil 50. A current is passed through the field coil 50 to excite the first magnetic pole 10 and the second magnetic pole 20 of the rotor 100. The first magnetic pole 10 and the second magnetic pole 20 are magnetized to, for example, the north pole and the south pole, respectively. As a result, the rotor 100 starts rotating with respect to the stator, and an electromotive force having an induced voltage is generated in the stator.

After that, the induced voltage increases according to the rotation speed of the rotor 100. When the rotation speed of the rotor 100 reaches the rotation speed of the first explosion lower than the idling rotation speed corresponding to the idling of the engine, the drive of the inverter is stopped. After that, it automatically shifts to a power generation mode, that is, a mode in which a rotary electric machine is used as a generator to exert a power generation function so as to maintain a predetermined induced voltage (required voltage).

In this power generation mode, when the field coil 50 is continuously excited, the exciting current is adjusted so that the induced voltage becomes constant at a predetermined induced voltage. When adjusting the exciting current, first, the exciting current is adjusted so that the magnetization force of the field coil 50 becomes constant. When the rotor 100 rotates in this state, the rotary electric machine functions as a generator.

As a result, by connecting the engine and the rotary electric machine, the engine can be started and the rotary electric machine can function as a generator (generator) during traveling.

The first engaging portion 32 of the annular first holding member 30 can abut on the outer peripheral surface of the tip portion of the first claw portion 12. Similarly, the second engaging portion 42 of the annular second holding member 40 can abut on the outer peripheral surface of the tip portion of the second claw portion 22. Therefore, while the rotor 100 is rotating with respect to the stator, the tip portions of the first claw portion 12 and the second claw portion 22 are subjected to the first holding member 30 and the second holding member 40, resulting suppressing the deformation by spreading to the outer peripheral side beyond the inner diameter of the above.

Further, when the first holding member 30 is attached by means such as press fitting, cutting chips are generated. When the rotor 100 includes the permanent magnet 60, there arises a problem that the cutting chips adhere to the permanent magnet 60 and the function of the permanent magnet 60 deteriorates. However, in the present embodiment, the inner diameter of the first engaging portion 32 of the first holding member 30 is larger than the outer diameter of the virtual cylinder formed by the outer peripheral surface of the tip portion of the plurality of first claw portion 12. That is, there is a gap between the inner peripheral surface of the first engaging portion 32 of the first holding member 30 and the outer peripheral surface of the virtual cylinder formed by the outer peripheral surfaces of the tip portions of the plurality of first claw portions 12. Since it has this gap, it can be mounted by fitting the gap when mounting the first holding member 30. Therefore, even when the rotor 100 includes the permanent magnet 60, there is no problem that the function of the permanent magnet 60 is deteriorated due to cutting chips.

Here, if there is a gap between the inner peripheral surface of the first engaging portion 32 of the first holding member 30 and the outer peripheral surface of the virtual cylinder formed by the outer peripheral surfaces of the tip portions of the plurality of first claw portions 12, when the rotor 100 rotates, the first holding member 30 and the first claw portion 12 rotate relative to each other, causing a problem that the first holding member 30 and/or the first claw portion 12 wears. However, in the rotor 100 of the present application, when the rotor 100 rotates, the tip portions of the plurality of first claw portions 12 open to the outer peripheral side, and abut with the inner peripheral surface of the first engaging portion 32 of the first holding member 30. As a result, the first holding member 30 is fixed. Therefore, there is no problem that the first holding member 30 and the first claw portion 12 rotate relative to each other and the first holding member 30 and/or the first claw portion 12 is worn.

### OTHER PREFERRED EMBODIMENTS

The present invention is not limited to the above embodiments, and various modifications can be made without departing from the scope of the present invention.

### Modification 1

In the above embodiment, the second claw portion 22 includes the second leg portion 22a and the second protrusion portion 22b. However, the present invention is not particularly limited to this. The second claw portion 22 may not include the second leg portion 22a, and the second protrusion 22b may extend directly from the second side in the axial direction of the second annular portion 21.

Similarly, in the above embodiment, the first claw portion 12 includes the first leg portion 12a and the first protrusion portion 12b. However, the present invention is not particularly limited to this. The first claw portion 12 may not include the first leg portion 12a, and the first protrusion portion 12b may extend directly from the second side in the axial direction of the first annular portion 11.

### Modification 2

In the above embodiment, the fourth engaging recess 24 is provided on the second claw portion 22, and the first engaging portion 32 is engaged with the fourth engaging recess 24. However, the present invention is not particularly limited to this. For example, in Modification 1, the fourth engaging recess 24 may be disposed on the outer peripheral portion of the second annular portion 21 on the first side in the axial direction.

Similarly, in the above embodiment, the second engaging recess 14 is provided in the first claw portion 12 and engaged with the second engaging portion 42. However, the present invention is not particularly limited to this. For example, in Modification 1, the second engaging recess 14 may be disposed on the outer peripheral portion of the first annular portion 11 on the second side in the axial direction.

### Modification 3

In the above embodiment, the rotor 100 of the rotary electric machine is attached to an impeller shell 201 of the torque converter 200. However, the present invention is not particularly limited to this. The rotor 100 of the rotary electric machine may be attached to another device. Another device is, for example, a damper.

### Modification 4

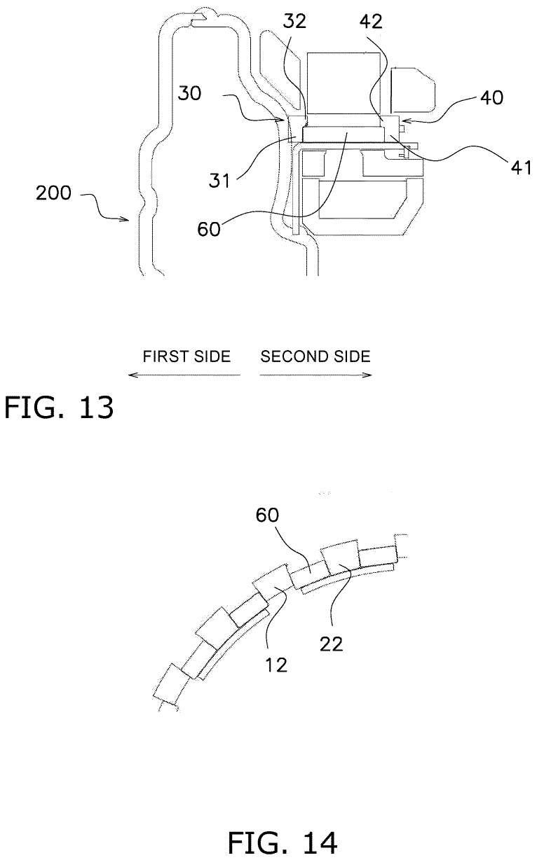

In the above embodiment, the permanent magnet 60 is supported by being pressed from the outside in the radial direction by the first claw portion 12 of the first magnetic pole 10 and the second claw portion 22 of the second magnetic pole 20. However, the present invention is not particularly limited to this. As shown in FIG. 13, the permanent magnet 60 may be supported by being pressed from the outside in the radial direction by the first engaging portion 32 of the first holding member 30 and the second engaging portion 42 of the second holding member 40. The end portion of the permanent magnet 60 on the first side in the axial direction may be in contact with the first main body portion 31 of the first holding member 30, and the second end portion of the permanent magnet 60 may be in contact with the second main body portion 41 of the second holding member 40. In this case, as shown in FIG. 14, the first claw portion 12 and the second claw portion 22 do not need a structure for pressing the permanent magnet 60 from the outside in the radial direction. Therefore, the construction method of the first magnetic pole 10 and the second magnetic pole 20 can be simplified.

### REFERENCE SIGNS LIST

10 First magnetic pole
11 First annular portion
12 First claw portion
13 First engaging recess
14 Second engaging recess
20 Second magnetic pole
21 Second annular portion
22 Second claw portion
23 Third engaging recess
24 Fourth engaging recess
30 First holding member
31 First main body portion
32 First engaging portion
40 Second holding member
41 Second main body portion
42 Second engaging portion
50 Field coil
60 Permanent magnet
70 Fall-out prevention mechanism
71 Plate
72 Snap ring
80 Core plate
81 Annular base portion
82 Engaging protrusion portion
100 Rotor of rotary electric machine
200 Torque converter

What is claimed is:

1. A rotor of a rotary electric machine comprising:
a first magnetic pole including a first annular portion and a plurality of first claw portions extending axially from the first annular portion, the plurality of first claw portions disposed at intervals from each other in a circumferential direction;
a second magnetic pole including a second annular portion disposed on a first side in an axial direction with respect to the first annular portion, and a plurality of second claw portions extending axially from the second annular portion, the plurality of second claw portions disposed alternately with the plurality of first claw portions in the circumferential direction;
a first holding member including an annular first engaging portion disposed radially outward with respect to tip portions of the plurality of the first claw portions; and
a second holding member including an annular second engaging portion disposed radially outward with respect to tip portions of the plurality of the second claw portions.

2. The rotor of the rotary electric machine according to claim 1, wherein
an inner diameter of the first engaging portion is larger than an outer diameter of a virtual cylinder formed by outer peripheral surfaces of the tip portions of the plurality of first claw portions, and
an inner diameter of the second engaging portion is larger than an outer diameter of a virtual cylinder formed by outer peripheral surfaces of the tip portions of the plurality of second claw portions.

3. The rotor of the rotary electric machine according to claim 1, wherein
the first holding member further includes an annular first main body portion, and
the first engaging portion extends from the first main body portion to a second side in the axial direction.

4. The rotor of the rotary electric machine according to claim 3, wherein
each of the plurality of the first claw portions includes a first engaging recess extending in the circumferential direction at outer peripheral portions of the tip portions, and
the first engaging portion is configured to engage the first engaging recess.

5. The rotor of the rotary electric machine according to claim 1, further comprising:
a field coil disposed radially inward with respect to the plurality of the first claw portions and the plurality of the second claw portions.

6. The rotor of the rotary electric machine according to claim 5, wherein
the field coil is longer than the plurality of the first claw portions in the axial direction.

7. The rotor of the rotary electric machine according to claim 1, further comprising:
a permanent magnet disposed between the plurality of the first claw portions and the plurality of the second claw portions in the circumferential direction.

8. The rotor of the rotary electric machine according to claim 1, further comprising:
a fall-out prevention mechanism disposed on the second side in the axial direction with respect to the second holding member.

9. The rotor of the rotary electric machine according to claim 8, wherein
the fall-out prevention mechanism includes an annular plate and a snap ring disposed on the second side in the axial direction with respect to the plate.
